(19) United States
(12) Patent Application Publication
(10) Pub. No.: US 2003/0046963 A1
(43) Pub. Date: Mar. 13, 2003

(54) Selective laundry process using water

(76) Inventors: William Michael Scheper, Lawrenceburg, IN (US); John Christian Haught, West Chester, OH (US); John Christopher Deak, Clarks Summit, PA (US); Paul Amaat Raymond Gerald France, West Chester, OH (US); John Cort Severns, West Chester, OH (US); Anna Vadimovna Radomyselski, Hamilton, OH (US); Christiaan Arthur Jacques Kamiel Thoen, West Chester, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/237,337

(22) Filed: Sep. 9, 2002

Related U.S. Application Data
(60) Provisional application No. 60/318,650, filed on Sep. 10, 2001.

(51) Int. Cl. C11D 7/18

(52) U.S. Cl. 68/12.21; 510/367; 510/276

(57) ABSTRACT

A process for cleaning fabric articles, especially articles of clothing, linen and drapery, with lipophilic fluid and water to provide improved cleaning of soils while providing excellent garment care, especially for articles sensitive to water.

### RELATED APPLICATIONS

This application claims priority to U.S. Provisional Application Serial No. 60/318,650 filed on Sep. 10, 2001.

### FIELD OF THE INVENTION

The present invention relates to a fabric article cleaning system, especially a system for use in a consumer's home, utilizing a lipophilic fluid and a low level of water in an automatic laundry machine capable of delivering different levels of water to the wash medium based on the type of fabric articles being cleaned.

### BACKGROUND OF THE INVENTION

Recently, a non-aqueous solvent based fabric article cleaning system, especially a dry cleaning system, utilizing a lipophilic fluid, such as cyclic siloxanes (especially cyclopentasiloxanes, sometimes termed “D5”), has been developed. Such a system is particularly desired for cleaning textile articles without causing damage associated with wet-washing, like shrinkage and dye transfer. To maximize fabric article cleaning in such a system, especially to remove hydrophilic soils, it is highly desirable to use some water along with laundry additives for cleaning, softening, finishing, etc. However, the level of water which can safely be used in such methods varies significantly depending on the type of fabric articles being cleaned.

The present invention is directed to a convenient, safe and effective system for cleaning a variety of fabric articles (including dry clean only garments) which is especially useful for a consumer to use in the home.

### SUMMARY OF THE INVENTION

The present invention relates to a method (process) for cleaning fabric articles in need of cleaning comprising contacting the fabric articles in need of cleaning with a cleaning composition comprising a lipophilic fluid and water; wherein the amount of cleaning composition comprising a lipophilic fluid and water; wherein the amount of water present in the cleaning composition is selected based upon the type of fabric articles being cleaned.

The present invention also provides a method (process) for cleaning fabric articles in need of cleaning comprising contacting the fabric articles in need of cleaning with a cleaning composition comprising a lipophilic fluid and water; wherein the amount of water present in the cleaning composition is selected based upon the amount of soil on the fabric articles to be cleaned.

In another aspect of the present invention, an apparatus, for example an automatic laundry machine, preferably an automatic home laundry machine, is provided.

In yet another aspect of the present invention, a method wherein the fabric articles to be cleaned are contacted by the lipophilic fluid prior to being contacted separately by water is provided.

In still yet another aspect of the present invention, a method for cleaning fabric articles in need of cleaning comprising contacting the fabric articles with a cleaning composition comprising a lipophilic fluid and a lipophilic cosolvent, wherein the lipophilic cosolvent is present in the cleaning composition at a level of from about 0.1% to about 35% by weight of the cleaning composition, wherein the lipophilic cosolvent forms an azeotrope with water such that water can be incorporated into the cleaning composition as a third solvent in the cleaning composition; and wherein the water is present in the cleaning composition at a level of from about 0.5% to about 25% by weight of the cleaning composition.

Even though the amount of water may be selected based upon different characteristics; namely, fabric article type or amount of soil on the fabric article, the cleaning process and the apparatus used in the methods of the present invention are similar.

The features and advantages of such washing process using a lipophilic fluid and water will become apparent to those of ordinary skill in the art from a reading of the following detailed description and the appended claims. All percentages, ratios and proportions herein are by weight, unless otherwise specified. All temperatures are in degrees Celsius (°C.) unless otherwise specified. All measurements are in SI units unless otherwise specified. All documents cited are in relevant part, incorporated herein by reference.

### DETAILED DESCRIPTION OF THE INVENTION

Definitions:

The term “fabric article” used herein is intended to mean any article that is customarily cleaned in a conventional laundry process or in a dry cleaning process. As such the term encompasses articles of clothing, linen, drapery, and clothing accessories. The term also encompasses other items made in whole or in part of fabric, such as tote bags, furniture covers, tarpaulins and the like.

The term “machine washable fabric articles”, as used herein, means those fabric articles readily identified by the fabric industry and consumers as safe for laundering by a conventional aqueous automatic home laundry process. Consumers are frequently helped in this identification of fabric articles by manufacturer's tags identifying the fabric article as “machine washable” or some similar description.

The term “dry clean only fabric articles”, as used herein, means those fabric articles readily identified by the fabric industry and consumers as unsafe for laundering by a conventional aqueous automatic home laundry process, and instead requiring special handling with a conventional non-aqueous solvent such as Perc. Again, consumers are frequently helped in this identification of fabric articles by manufacturer's tags indentifying the fabric article as “dry clean only” or some similar description.

The term “lipophilic fluid” used herein is intended to mean any nonaqueous fluid capable of removing sebum, as described in more detail herein below.

The term “cleaning composition” and/or “treating composition” used herein are intended to mean any lipophilic fluid-containing composition that comes into direct contact with fabric articles to be cleaned. It should be understood that the term encompasses uses other than cleaning, such as conditioning and sizing.

The term “soil” means any undesirable substance on a fabric article that is desired to be removed. By the terms “water-based” or “hydrophilic” soils, it is meant that the soil comprised water at the time it first came in contact with the fabric article, that the soil has high water solubility or affinity, or the soil retains a significant portion of water on the fabric article. Examples of water-based soils include, but are not limited to beverages, many food soils, water soluble dyes, bodily fluids such as sweat, urine or blood, outdoor soils such as grass stains and mud.

The term “capable of suspending water in a lipophilic fluid” means that a material is able to suspend, solvate or emulsify water, which is immiscible with the lipophilic fluid, in a way that the water remains visibly suspended, solvated or emulsified when left undisturbed for a period of at least five minutes after initial mixing of the components.

The term “insoluble in a lipohilic fluid” means that when added to a lipophilic fluid, a material physically separates from the lipophilic fluid (i.e. settle-out, flocculate, float) within 5 minutes after addition, whereas a material that is “soluble in a lipophilic fluid” does not physically separate from the lipophilic fluid within 5 minutes after addition.

The term “consumable detergent composition” means any composition, that when combined with a lipophilic fluid, results in a cleaning composition useful according to the present invention process.

The term “processing aid” refers to any material that renders the consumable detergent composition more suitable for formulation, stability, and/or dilution with a lipophilic fluid to form a cleaning composition useful for the present invention process.

The term “mixing” as used herein means combining two or more materials (i.e., fluids, more specifically a lipophilic fluid and a consumable detergent composition) in such a way that a homogeneous mixture is formed. Suitable mixing processes are known in the art. Nonlimiting examples of suitable mixing processes include vortex mixing processes and static mixing processes.

Process Description:

The present invention process may be described as follows. The present invention is a method for cleaning fabric articles in need of cleaning comprising contacting said fabric articles in need of cleaning with a cleaning composition comprising a lipophilic fluid and water (i.e., low level of water preferably less than 50%, more preferably less than 40% by weight of the cleaning composition), preferably in an automatic laundry machine. The amount of water in the cleaning composition is selected based upon the type of fabric articles being cleaned.

The level of water utilized can vary significantly depending on the fabric article to be cleaned. Limitations on the level of water to be used based on fabric article type are as follows: silks use less than about 1% water; rayons use less than about 2% water; wools also use less than about 2% water; cottons and polycottons generally can safely be contacted with any level of water; the need for reasonable drying times (preferably less than 1 hour, more preferably less than 45 minutes); and reasonable limits on the amount of water that needs to be separated from the lipophilic fluid if the lipophilic fluid is to be cleaned and reused (which is highly desirable). In one embodiment, the amount of water used in the process is less than about 20% and/or less than about 10% and/or less than about 5% by weight of the cleaning composition.

In one embodiment, if the fabric articles to be cleaned comprise a fabric article selected from the group consisting of silks, wools, rayon and mixtures thereof, then the cleaning composition may comprise less than about 1% by weight of the cleaning composition of water.

In another embodiment, if the fabric articles to be cleaned do not include a fabric article selected from the group consisting of silks, wools, rayon and mixtures thereof, (for example they include a fabric article selected from the group consisting of cotton, polyester, nylon, and polycottons and mixtures thereof), then the cleaning composition may comprise less than about 50% water and/or less than 25% water and/or less than 10% by weight of the cleaning composition of water.

For wash loads that contain more than one fabric article type, the level of water used must be selected to safely contact the most water sensitive fabric article in the load. For example, a wash load containing both cotton and wool fabric articles must use a level of water less than about 2% as needed to safely contact the wool fabric articles in the load. If a silk fabric article is also present, then the water level selected would be less than about 1%. For loads that contain dry clean only fabric articles (with or without machine washable fabric articles also being present in the wash load), it is highly preferred to use less than about 1% water unless the load does not contain any silk fabric articles, then the water level selected may be 2%.

The preferred methods of the present invention use an automatic laundry machine preprogrammed to deliver a select level of water in combination with a lipophilic fluid based on the type of fabric articles to be cleaned. One method involves the use of a machine that automatically selects the level of water to be use. The selection of the level of water by the machine may be in response to a sensor in the machine which detects the types of fabric article being cleaned. For example, the machine may have a sensor that reads labels attached to the fabric articles in the wash load and selects the water level safe for all the fabric articles being cleaned or notifies the operator of problems with the machine options available for making such a selection.

The automatic selection may also be in response to information about the fabric articles to be cleaned provided to the machine by the operator (e.g., the consumer when the process is practiced in the home with a home laundry machine according to the present invention). The machine operator may also be able to select the level of water to be used from the preprogrammed machine options (for example, the machine may have a “silk load” setting, a “wool/rayon” load setting, and a “cotton load” setting that the operator can select based on knowledge of the fabric articles selected for cleaning; or “dry clean only fabric articles” and “machine washable fabric articles only” settings).

Because the fabric articles themselves may bring into the wash process different levels of water (e.g., wet towels versus dry towels being added to the automatic laundry machine), it is highly desirable that the automatic laundry machines used for the present invention process have a water level sensor which can measure the level of water present during the wash process when the fabric articles are contacted with the cleaning composition containing the lipophilic fluid. This sensor preferably limits the level of purposefully added water, if any, which is also introduced into the wash medium, such that if the water level is lower than desired for maximizing the cleaning of the fabric articles being contacted with the cleaning composition, then purposefully added water is metered into the wash process to the level selected for the fabric articles being cleaned. If the water level exceeds the level selected, then the machine preferably is designed to quickly and efficiently remove the water present in the cleaning composition to the selected level (e.g., by cycling the cleaning composition through a separator system designed to remove water and cycle the cleaning composition back into contact with the fabric articles).

Detergents (and/or other fabric article products) comprising one or more laundry additives is preferably added to lipophilic fluid and/or water either before or after the cleaning composition contacts the fabric articles in need of cleaning in the automatic washing machine. The cleaning composition may contain water added as part of the consumable detergent composition and/or by separate addition from a source of water connected to the machine. After the wash cycle, the cleaning composition is drained from drum of the machine and one or more of these laundry additives as well as the water present in the cleaning composition are separated from lipophilic fluid. Preferred mode of separation is extraction of additives into a water phase that is introduced during the process of purifying the lipophilic fluid for reuse by the machine. As such, water can be added during the separation step to enhance the extraction of additives and other contaminants. Together with this water one can add “extraction aids” such as hydrotopes and emulsifiers. Prefered hydrotrope is a short chain, low ethoxylated nonionic such as Dehydol™. Other modes of separation are filtration, coalescence, adsorption, centrifugation, and distillation. Removal of laundry additives is such that the lipophilic fluid is sufficiently clean of laundry additives and soil contaminants that it is ready for use with next load of fabric article to be cleaned. In a preferred system, the water phase containing laundry additives (and likely also some of the soil removed from the fabric articles) is substantially free of lipophilic fluid and is safe for disposal down the drain.

An automatic washing machine useful according to the present invention is any machine designed to clean fabric articles with a cleaning composition containing lipophilic fluid and water, and being capable of carrying out the wash process of the present invention by delivering different levels of water to the fabric articles based on the fabric articles to be cleaned. While the machine will typically have a rotating drum capable of contacting the lipophilic fluid and laundry additives with the fabric articles to be cleaned, for purposes of this invention any method for contacting the lipophilic fluid and water with the fabric article is envisioned, obviously as long as such contact permits the cleaning process to occur. Such machines must comprise a connection for supplying lipophilic fluid (alone or with the water and optionally the laundry additives already mixed therewith) into a chamber for contacting the fabric articles to be cleaned with the lipophilic fluid and selected level of water. Preferred machines also comprise a storage chamber for storing the lipophilic fluid to be supplied to the wash process carried out in the machine. Thus, these machines typically have a source of lipophilic fluid. The machines also comprise a separation system capable of separating the lipophilic fluid from the water and laundry additives during or after the fabric article cleaning process in order to reuse the lipophilic fluid. Further the present invention machines preferably comprise a connection for attachment to an aqueous waste removal system such that at least some (preferably all) of the water and laundry additives removed by the separation system are disposed of down the drain. Preferred machines also have a connection for attachment to a source of water, typically tap water, to provide a meterable source of water for addition to the cleaning composition at the desired level. If tap water is to be used, such water source preferably is filtered or otherwise treated prior to introduction into contact with the fabric articles to reduce the water “hardness” by removing dissolved materials. Such a water filter may be part of the machine or part of the home water treatment system. The present invention machines also preferably have the above noted sensors (to detect fabric article types in the wash load and/or to measure the water level present in the wash medium in contact with the fabric articles being cleaned) and/or are preferably preprogrammed to deliver the selected level of water based on the fabric article types being cleaned.

“Substantially free of lipophilic fluid”, as used herein, means that the aqueous mixture to be disposed of down the drain does not contain unacceptably high levels (for example, no more than 5% and/or 3% and/or 1% and/or less than 1% by weight of the aqueous mixture to be disposed of down the drain) of lipophilic fluid as determined by both environmental safety and cost of replacement of the lost lipophilic fluid from the washing machine store of lipophilic fluid. Since it is highly desireable that essentially all the lipophilic fluid be reused in the current wash system, it is highly desireable that very little if any of the lipophilic fluid is disposed of down the drain with the above-noted aqueous phase containing laundry additives.

“Down the drain”, as used herein, means both the conventional in-home disposal of materials into the municipal water waste removal systems such as by sewer systems or via site specific systems such as septic systems, as well as for commercial applications the removal to on-site water treatment systems or some other centralized containment means for collecting contaminated water from the facility.

Lipophilic Fluid

The lipophilic fluid herein is one having a liquid phase present under operating conditions of a fabric article treating appliance, in other words, during treatment of a fabric article in accordance with the present invention. In general such a lipophilic fluid can be fully liquid at ambient temperature and pressure, can be an easily melted solid, e.g., one which becomes liquid at temperatures in the range from about 0 deg. C. to about 60 deg. C., or can comprise a mixture of liquid and vapor phases at ambient temperatures and pressures, e.g., at 25 deg. C. and 1 atm. pressure. Thus, the lipophilic fluid is not a compressible gas such as carbon dioxide.

It is preferred that the lipophilic fluids herein be nonflammable or have relatively high flash points and/or low VOC (volatile organic compound) characteristics, these terms having their conventional meanings as used in the dry cleaning industry, to equal or, preferably, exceed the characteristics of known conventional dry cleaning fluids.

Moreover, suitable lipophilic fluids herein are readily flowable and nonviscous.

In general, lipophilic fluids herein are required to be fluids capable of at least partially dissolving sebum or body soil as defined in the test hereinafter. Mixtures of lipophilic fluid are also suitable, and provided that the requirements of the Lipophilic Fluid Test, as described below, are met, the lipophilic fluid can include any fraction of dry-cleaning solvents, especially newer types including fluorinated solvents, or perfluorinated amines. Some perfluorinated amines such as perfluorotributylamines while unsuitable for use as lipophilic fluid may be present as one of many possible adjuncts present in the lipophilic fluid-containing composition.

Other suitable lipophilic fluids include, but are not limited to, diol solvent systems e.g., higher diols such as C6- or C8- or higher diols, organosilicone solvents including both cyclic and acyclic types, and the like, and mixtures thereof.

A preferred group of nonaqueous lipophilic fluids suitable for incorporation as a major component of the compositions of the present invention include low-volatility nonfluorinated organics, silicones, especially those other than amino functional silicones, and mixtures thereof. Low volatility nonfluonnated organics include for example OLEAN® and other polyol esters, or certain relatively nonvolatile biodegradable mid-chain branched petroleum fractions.

Another preferred group of nonaqueous lipophilic fluids suitable for incorporation as a major component of the compositions of the present invention include, but are not limited to, glycol ethers, for example propylene glycol methyl ether, propylene glycol n-propyl ether, propylene glycol t-butyl ether, propylene glycol n-butyl ether, dipropylene glycol methyl ether, dipropylene glycol n-propyl ether, dipropylene glycol t-butyl ether, dipropylene glycol n-butyl ether, tripropylene glycol methyl ether, tripropylene glycol n-propyl ether, tripropylene glycol t-butyl ether, tripropylene glycol n-butyl ether. Suitable silicones for use as a major component, e.g., more than 50%, of the composition include cyclopentasiloxanes, sometimes termed “D5”, and/or linear analogs having approximately similar volatility, optionally complemented by other compatible silicones. Suitable silicones are well known in the literature, see, for example, Kirk Othmer's Encyclopedia of Chemical Technology, and are available from a number of commercial sources, including General Electric, Toshiba Silicone, Bayer, and Dow Coming. Other suitable lipophilic fluids are commercially available from Procter & Gamble or from Dow Chemical and other suppliers.

### Qualification of Lipophilic Fluid and Lipophilic Fluid Test (LF Test)

Any nonaqueous fluid that is both capable of meeting known requirements for a dry-cleaning fluid (e.g, flash point etc.) and is capable of at least partially dissolving sebum, as indicated by the test method described below, is suitable as a lipophilic fluid herein. As a general guideline, perfluorobutylamine (Fluorinert FC-43®) on its own (with or without adjuncts) is a reference material which by definition is unsuitable as a lipophilic fluid for use herein (it is essentially a nonsolvent) while cyclopentasiloxanes have suitable sebum-dissolving properties and dissolves sebum.

The following is the method for investigating and qualifying other materials, e.g., other low-viscosity, free-flowing silicones, for use as the lipophilic fluid. The method uses commercially available Crisco® canola oil, oleic acid (95% pure, available from Sigma Aldrich Co.) and squalene (99% pure, available from J. T. Baker) as model soils for sebum. The test materials should be substantially anhydrous and free from any added adjuncts, or other materials during evaluation.

Prepare three vials, each vial will contain one type of lipophilic soil. Place 1.0 g of canola oil in the first; in a second vial place 1.0 g of the oleic acid (95%), and in a third and final vial place 1.0 g of the squalene (99.9%). To each vial add 1 g of the fluid to be tested for lipophilicity. Separately mix at room temperature and pressure each vial containing the lipophilic soil and the fluid to be tested for 20 seconds on a standard vortex mixer at maximum setting. Place vials on the bench and allow to settle for 15 minutes at room temperature and pressure. If, upon standing, a clear single phase is formed in any of the vials containing lipophilic soils, then the nonaqueous fluid qualifies as suitable for use as a “lipophilic fluid” in accordance with the present invention. However, if two or more separate layers are formed in all three vials, then the amount of nonaqueous fluid dissolved in the oil phase will need to be further determined before rejecting or accepting the nonaqueous fluid as qualified.

In such a case, with a syringe, carefully extract a 200-microliter sample from each layer in each vial. The syringe-extracted layer samples are placed in GC auto sampler vials and subjected to conventional GC analysis after determining the retention time of calibration samples of each of the three models soils and the fluid being tested. If more than 1% of the test fluid by GC, preferably greater, is found to be present in any one of the layers which consists of the oleic acid, canola oil or squalene layer, then the test fluid is also qualified for use as a lipophilic fluid. If needed, the method can be further calibrated using heptacosafluorotributylamine, i.e., Fluorinert FC-43 (fail) and cyclopentasiloxane (pass). A suitable GC is a Hewlett Packard Gas Chromatograph HP5890 Series II equipped with a split/splitless injector and FID. A suitable column used in determining the amount of lipophilic fluid present is a J&W Scientific capillary column DB-1HT, 30 meter, 0.25 mm id, 0.1 um film thickness cat#1221131. The GC is suitably operated under the following conditions:

Carrier Gas: Hydrogen

Column Head Pressure: 9 psi

Flows: Column Flow @˜15 ml/min.

Split Vent @˜250-500 ml/min.

Septum Purge @1 ml/min.

Injection: HP 7673 Autosampler, 10 ul syringe, 1 ul injection

Injector Temperature: 350° C.

Detector Temperature: 380° C.

Oven Temperature Program: initial 60° C. hold 1 min.

rate 25° C./min.

final 380° C. hold 30 min.

Preferred lipophilic fluids suitable for use herein can further be qualified for use on the basis of having an excellent garment care profile. Garment care profile testing is well known in the art and involves testing a fluid to be qualified using a wide range of garment or fabric article components, including fabrics, threads and elastics used in seams, etc., and a range of buttons. Preferred lipophilic fluids for use herein have an excellent garment care profile, for example they have a good shrinkage and/or fabric puckering profile and do not appreciably damage plastic buttons. Certain materials which in sebum removal qualify for use as lipophilic fluids, for example ethyl lactate, can be quite objectionable in their tendency to dissolve buttons, and if such a material is to be used in the compositions of the present invention, it will be formulated with water and/or other solvents such that the overall mix is not substantially damaging to buttons. Other lipophilic fluids, D5, for example, meet the garment care requirements quite admirably. Some suitable lipophilic fluids may be found in granted U.S. Pat. Nos. 5,865,852; 5,942,007; 6,042,617; 6,042,618; 6,056,789; 6,059,845; and 6,063,135, which are incorporated herein by reference.

Lipophilic fluids can include linear and cyclic polysiloxanes, hydrocarbons and chlorinated hydrocarbons, with the exception of PERC and DF2000 which are explicitly not covered by the lipophilic fluid definition as used herein. More preferred are the linear and cyclic polysiloxanes and hydrocarbons of the glycol ether, acetate ester, lactate ester families. Preferred lipophilic fluids include cyclic siloxanes having a boiling point at 760 mm Hg. of below about 250° C. Specifically preferred cyclic siloxanes for use in this invention are octamethylcyclotetrasiloxane, decamethylcyclopentasiloxane, and dodecamethylcyclohexasiloxane. Preferably, the cyclic siloxane comprises decamethylcyclopentasiloxane (D5, pentamer) and is substantially free of octamethylcyclotetrasiloxane (tetramer) and dodecamethylcyclohexasiloxane (hexamer).

However, it should be understood that useful cyclic siloxane mixtures might contain, in addition to the preferred cyclic siloxanes, minor amounts of other cyclic siloxanes including octamethylcyclotetrasiloxane and hexamethylcyclotrisiloxane or higher cyclics such as tetradecamethylcycloheptasiloxane. Generally the amount of these other cyclic siloxanes in useful cyclic siloxane mixtures will be less than about 10 percent based on the total weight of the mixture. The industry standard for cyclic siloxane mixtures is that such mixtures comprise less than about 1% by weight of the mixture of octamethylcyclotetrasiloxane.

Accordingly, the lipophilic fluid of the present invention preferably comprises more than about 50%, more preferably more than about 75%, even more preferably at least about 90%, most preferably at least about 95% by weight of the lipophilic fluid of decamethylcyclopentasiloxane. Alternatively, the lipophilic fluid may comprise siloxanes which are a mixture of cyclic siloxanes having more than about 50%, preferably more than about 75%, more preferably at least about 90%, most preferably at least about 95% up to about 100% by weight of the mixture of decamethylcyclopentasiloxane and less than about 10%, preferably less than about 5%, more preferably less than about 2%, even more preferably less than about 1%, most preferably less than about 0.5% to about 0% by weight of the mixture of octamethylcyclotetrasiloxane and/or dodecamethylcyclohexasiloxane.

The level of lipophilic fluid present in the cleaning compositions according to the present invention may be from about 70% to about 99.99% and/or from about 90% to about 99.9% and/or from about 95% to about 99.8% by weight of the cleaning composition. The level of lipophilic fluid, when present in a consumable detergent composition useful for the present invention, may be from about 0% to about 90% and/or from about 0.1% to about 75% and/or from about 1% to about 50% by weight of the consumable detergent composition.

Laundry Additives:

Detergent compositions useful herein comprise laundry additives. “Laundry additives” as used herein, means additives useful in a lipophilic fluid-based cleaning system, and preferably are selected from those materials that can be safely disposed down the drain within all constraints on environmental fate and toxicity (e.g. biodegradability, aquatic toxicity, pH, etc.). Although solubility in water or lipophilic fluid are not necessarily required, preferred materials are simultaneously soluble in both water and lipophilic fluid. The laundry additives can vary widely and can be used at widely ranging levels.

Some suitable laundry additives include, but are not limited to, builders, surfactants, enzymes, bleach activators, bleach catalysts, bleach boosters, bleaches, alkalinity sources, antibacterial agents, colorants, perfumes, pro-perfumes, finishing aids, lime soap dispersants, odor control agents, odor neutralizers, polymeric dye transfer inhibiting agents, crystal growth inhibitors, photobleaches, heavy metal ion sequestrants, anti-tarnishing agents, anti-microbial agents, anti-oxidants, anti-redeposition agents, soil release polymers, electrolytes, pH modifiers, thickeners, abrasives, divalent or trivalent ions, metal ion salts, enzyme stabilizers, corrosion inhibitors, diamines or polyamines and/or their alkoxylates, suds stabilizing polymers, solvents, process aids, fabric softening agents, optical brighteners, hydrotropes, suds or foam suppressors, suds or foam boosters and mixtures thereof.

A preferred surfactant laundry additive is a material that is capable of suspending water in a lipophilic fluid and enhancing soil removal benefits of a lipophilic fluid. As a condition of their performance, said materials are soluble in the lipophilic fluid. One preferred class of materials is siloxane-based surfactants. Such materials, derived from poly(dimethylsiloxane), are well known in the art. For the present invention, not all such siloxane materials are suitable, either because they are insoluble in the lipophilic fluid and/or because they do not provide improved cleaning of soils compared to the level of cleaning provided by the lipophilic fluid itself.

Surfactant Component

The surfactant component of the present invention can be a material that is capable of suspending water in a lipophilic fluid and/or enhancing soil removal benefits of a lipophilic fluid. The materials may be soluble in the lipophilic fluid.

One class of materials can include siloxane-based surfactants (siloxane-based materials). The siloxane-based surfactants in this application may be siloxane polymers for other applications. The siloxane-based surfactants typically have a weight average molecular weight from 500 to 20,000. Such materials, derived from poly(dimethylsiloxane), are well known in the art. In the present invention, not all such siloxane-based surfactants are suitable, because they do not provide improved cleaning of soils compared to the level of cleaning provided by the lipophilic fluid itself.

Suitable siloxane-based surfactants comprise a polyether siloxane having the formula:

MₐD_{b}D′_{c}D″_{d}M′₂₋ₐ

wherein

a is 0-2; b is 0-1000; c is 0-50; d is 0-50, provided that a+c+d is at least 1;

M is R¹₃₋ₑXₑSiO_{1/2} wherein R¹ is independently H, or a monovalent hydrocarbon group, X is hydroxyl group, and e is 0 or 1;

M′ is R²₃SiO_{1/2} wherein R² is independently H, a monovalent hydrocarbon group, or (CH₂)_{f}—(C6H4)_{g}O—(C₂H₄)ₕ—(C₃H₆O)ᵢ—(CₖH₂ₖO)ⱼ—R³, provided that at least one R² is (CH₂)_{f}—(C6H4)_{g}O—(C₂H₄O)ₕ—(C₃H₆O)ᵢ—(CₖH₂ₖO)ⱼ—R³, wherein R³ is independently H, a monovalent hydrocarbon group or an alkoxy group, f is 1-10, g is 0 or 1, h is 1-50, i is 0-50, j is 0-50, k is 4-8;

D is R⁴₂SiO_{2/2} wherein R⁴ is independently H or a monovalent hydrocarbon group;

D′ is R⁵₂SiO_{2/2} wherein R⁵ is independently R² provided that at least one R⁵ is (CH₂)_{f}—(C6H4)_{g}O—(C₂H₄)ₕ—(C₃H₆O)ᵢ—(CₖH₂ₖO)ⱼ—R³, wherein R³ is independently H, a monovalent hydrocarbon group or an alkoxy group, f is 1-10, g is 0 or 1, h is 1-50, i is 0-50, j is 0-50, k is 4-8; and

D″ is R⁶₂SiO_{2/2} wherein R⁶ is independently H, a monovalent hydrocarbon group or (CH₂)₁(C₆H₄)ₘ(A)ₙ—[(L)ₒ—(A′)ₚ—]_{q}—(L′)ᵣZ(G)ₛ, wherein 1 is 1-10; m is 0 or 1; n is 0-5; o is 0-3; p is 0 or 1; q is 0-10; r is 0-3; s is 0-3;C₆H₄ is unsubstituted or substituted with a C₁₋₁₀ alkyl or alkenyl; A and A′ are each independently a linking moiety representing an ester, a keto, an ether, a thio, an amido, an amino, a C₁₋₄ fluoroalkyl, a C₁₋₄ fluoroalkenyl, a branched or straight chained polyalkylene oxide, a phosphate, a sulfonyl, a sulfate, an ammonium, and mixtures thereof. L and L′ are each independently a C₁₋₃₀ straight chained or branched alkyl or alkenyl or an aryl which is unsubstituted or substituted; Z is a hydrogen, carboxylic acid, a hydroxy, a phosphato, a phosphate ester, a sulfonyl, a sulfonate, a sulfate, a branched or straight-chained polyalkylene oxide, a nitryl, a glyceryl, an aryl unsubstituted or substituted with a C₁₋₃₀alkyl or alkenyl, a carbohydrate unsubstituted or substituted with a C₁₋₁₀alkyl or alkenyl or an ammonium; G is an anion or cation such as H⁺, Na⁺, Li⁺, K⁺, NH₄⁺, Ca⁺², Mg⁺², Cl⁻, Br⁻, I⁻, mesylate or tosylate.

Examples of the types of siloxane-based surfactants described herein above may be found in EP-1,043,443A1, EP-1,041,189 and WO-01/34,706 (all to GE Silicones) and U.S. Pat. Nos. 5,676,705, 5,683,977, 5,683,473, and EP-1,092,803A1 (all to Lever Brothers).

Nonlimiting commercially available examples of suitable siloxane-based surfactants are TSF 4446 (ex. General Electric Silicones), XS69-B5476 (ex. General Electric Silicones); Jenamine HSX (ex. DelCon) and Y12147 (ex. OSi Specialties).

A second preferred class of materials suitable for the surfactant component is organic in nature. Preferred materials are organosulfosuccinate surfactants, with carbon chains of from about 6 to about 20 carbon atoms. Most preferred are organosulfosuccinates containing dialkly chains, each with carbon chains of from about 6 to about 20 carbon atoms. Also preferred are chains containing aryl or alkyl aryl, substituted or unsubstituted, branched or linear, saturated or unsaturated groups.

Nonlimiting commercially available examples of suitable organosulfosuccinate surfactants are available under the trade names of Aerosol OT and Aerosol TR-70 (ex. Cytec).

The surfactant component, when present in the fabric article treating compositions of the present invention, preferably comprises from about 0.01% to about 10%, more preferably from about 0.02% to about 5%, even more preferably from about 0.05% to about 2% by weight of the fabric article treating composition.

The surfactant component, when present in the consumable detergent compositions of the present invention, preferably comprises from about 1% to about 99%, more preferably 2% to about 75%, even more preferably from about 5% to about 60% by weight of the consumable detergent composition.

A second preferred class of materials suitable for the surfactant component is organic in nature. Again, solubility in the lipophilic fluid, as identified above, is essential. Preferred materials are organosulfosuccinate surfactants, with carbon chains of from about 6 to about 20 carbon atoms.

Nonlimiting commercially available examples of suitable organosulfosuccinate surfactants are available under the trade names of Aerosol OT and Aerosol TR-70 (ex. Cytec).

Another preferred class of surfactants is nonionic surfactants, especially those having low HLB values. Preferred nonionic surfactants have HLB values of less than about 10, more preferably less than about 7.5, and most preferably less than about 5. Preferred nonionic surfactants also have from about 6-20 carbons in the surfactant chain and from about 1-15 ethylene oxide (EO) and/or propylene oxide (PO) units in the hydrophilic portion of the surfactant (i.e., C6-20 EO/PO 1-15), and preferably nonionic surfactants selected from those within C7-11 EO/PO 1-5 (e.g., C7-11 EO 2.5).

The surfactant laundry additives, when present, typically comprises from about 0.001% to about 10%, more preferably from about 0.01% to about 5%, even more preferably from about 0.02% to about 2% by weight of the cleaning composition combined with the lipophilic fluid for the present invention process. These surfactant laundry additives, when present in the consumable detergent compositions before addition to the lipophilic fluid, preferably comprises from about 1% to about 90%, more preferably 2% to about 75%, even more preferably from about 5% to about 60% by weight of the consumable detergent composition.

Non-silicone additives, if present, which preferably comprises a strongly polar and/or hydrogen-bonding head group, further enhances soil removal by the process of the present invention. Examples of the strongly polar and/or hydrogen-bonding head group are alcohols, carboxylic acids, sulfates, sulphonates, phosphates, phosphonates, and nitrogen containing materials. Preferred non-silicone additives are nitrogen containing materials selected from the group consisting of primary, secondary and tertiary amines, diamines, triamines, ethoxylated amines, amine oxides, amides, betaines, quaternary ammonium salts, and mixtures thereof. Alkylamines are particularly preferred. Additionally, branching on the alkyl chain to help lower the melting point is highly preferred. Even more preferred are primary alkylamines comprising from about 6 to about 22 carbon atoms.

Particularly preferred primary alkylamines are oleylamine (commercially available from Akzo under the trade name Armeen OLD), dodecylamine (commercially available from Akzo under the trade name Armeen 12D), branched C₁₆-C₂₂ alkylamine (commercially available from Rohm & Haas under the trade name Primene JM-T) and mixtures thereof.

The non-silicone additive, when present in the cleaning compositions used for the present invention process, preferably comprises from about 0.001% to about 10%, more preferably from about 0.01% to about 5%, even more preferably from about 0.02% to about 2% by weight of the cleaning composition. Non-silicone additives, when present in the consumable detergent compositions for the present invention process, preferably comprises from about 1% to about 90%, more preferably from about 2% to about 75%, even more preferably from about 5% to about 60% by weight of the consumable detergent composition.

As noted before, optionally, consumable detergent compositions useful in the present invention process may contain water. When present in the consumable detergent compositions, water preferably comprises from about 1% to about 90%, more preferably from about 2% to about 75%, even more preferably from about 5% to about 40% by weight of the consumable detergent composition.

Optionally, the compositions useful for the present invention process may comprise processing aids. Processing aids facilitate the formation of the cleaning compositions by maintaining the fluidity and/or homogeneity of the consumable detergent composition, and/or aiding in the dilution process. Processing aids suitable for the present invention are solvents, preferably solvents other than those described above, hydrotropes, and/or surfactants, preferably surfactants other than those described above with respect to the surfactant component. Particularly preferred processing aids are protic solvents such as aliphatic alcohols, diols, triols, etc. and nonionic surfactants such as ethoxylated fatty alcohols.

Processing aids, when present in the cleaning compositions, preferably comprise from about 0.02% to about 10%, more preferably from about 0.05% to about 10%, even more preferably from about 0.1% to about 10% by weight of the cleaning composition. Processing aids, when present in the consumable detergent compositions, preferably comprise from about 1% to about 75%, more preferably from about 5% to about 50% by weight of the consumable detergent composition.

Suitable odor control agents, which may optionally be used as finishing agents, include agents include, cyclodextrins, odor neutralizers, odor blockers and mixtures thereof. Suitable odor neutralizers include aldehydes, flavanoids, metallic salts, water-soluble polymers, zeolites, activated carbon and mixtures thereof.

Perfumes and perfumery ingredients useful in the compositions for the present invention process comprise a wide variety of natural and synthetic chemical ingredients, including, but not limited to, aldehydes, ketones, esters, and the like. Also included are various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes may comprise extremely complex mixtures of such ingredients. Pro-perfumes are also useful in the present invention. Such materials are those precursors or mixtures thereof capable of chemically reacting, e.g., by hydrolysis, to release a perfume, and are described in patents and/or published patent applications to Procter and Gamble, Firmenich, Givaudan and others.

Bleaches, especially oxygen bleaches, are another type of laundry additive suitable for use in the compositions for the present invention. This is especially the case for the activated and catalyzed forms with such bleach activators as nonanoyloxybenzenesulfonate and/or any of its linear or branched higher or lower homologs, and/or tetraacetylethylenediamine and/or any of its derivatives or derivatives of phthaloylimidoperoxycaproic acid (PAP; available from Ausimont SpA under trademane Euroco) or other imido- or amido-substituted bleach activators including the lactam types, or more generally any mixture of hydrophilic and/or hydrophobic bleach activators (especially acyl derivatives including those of the C₆-C₁₆ substituted oxybenzenesulfonates).

Also suitable are organic or inorganic peracids both including PAP and other than PAP. Suitable organic or inorganic peracids for use herein include, but are not limited to: percarboxylic acids and salts; percarbonic acids and salts; perimidic acids and salts; peroxymonosulfuric acids and salts; persulphates such as monopersulfate; peroxyacids such as diperoxydodecandioic acid (DPDA); magnesium peroxyphthalic acid; perlauric acid; perbenzoic and alkylperbenzoic acids; and mixtures thereof.

Detersive enzymes such as proteases, amylases, cellulases, lipases and the like as well as bleach catalysts including the macrocyclic types having manganese or similar transition metals all useful in laundry and cleaning products can be used herein at very low, or less commonly, higher levels. Laundry Additives that are catalytic, for example enzymes, can be used in “forward” or “reverse” modes. For example, a lipolase or other hydrolase may be used, optionally in the presence of alcohols as laundry additives, to convert fatty acids to esters, thereby increasing their solubility in the lipohilic fluid.

Nonlimiting examples of finishing polymers that are commercially available are: polyvinylpyrrolidone/dimethylaminoethyl methacrylate copolymer, such as Copolymer 958®, molecular weight of about 100,000 and Copolymer 937, molecular weight of about 1,000,000, available from GAF Chemicals Corporation; adipic acid/dimethylaminohydroxypropyl diethylenetriamine copolymer, such as Cartaretin F-4® and F-23, available from Sandoz Chemicals Corporation; methacryloyl ethyl betaine/methacrylates copolymer, such as Diaformer Z-SM®, available from Mitsubishi Chemicals Corporation; polyvinyl alcohol copolymer resin, such as Vinex 2019®, available from Air Products and Chemicals or Moweol®, available from Clariant; adipic acid/epoxypropyl diethylenetriamine copolymer, such as Delsette 101®, available from Hercules Incorporated; polyamine resins, such as Cypro 515®, available from Cytec Industries; polyquatemary amine resins, such as Kymene 557H®, available from Hercules Incorporated; and polyvinylpyrrolidone/acrylic acid, such as Sokalan EG 310®, available from BASF.

The laundry additive may also be an antistatic agent. Any suitable well-known antistatic agents used in conventional laundering and dry cleaning are suitable for use in the compositions and methods of the present invention. Especially suitable as antistatic agents are the subset of fabric softeners which are known to provide antistatic benefits. For example those fabric softeners that have a fatty acyl group which has an iodine value of above 20, such as N,N-di(tallowoyl-oxy-ethyl)-N,N-dimethyl ammonium methylsulfate. However, it is to be understood that the term antistatic agent is not to be limited to just this subset of fabric softeners and includes all antistatic agents.

Preferred insect and moth repellent laundry additives useful in the compositions of the present invention are perfume ingredients, such as citronellol, citronellal, citral, linalool, cedar extract, geranium oil, sandalwood oil, 2-(diethylphenoxy)ethanol, 1-dodecene, etc. Other examples of insect and/or moth repellents useful in the compositions of the present invention are disclosed in U.S. Pat. Nos. 4,449,987; 4,693,890; 4,696,676; 4,933,371; 5,030,660; 5,196,200; and in “Semio Activity of Flavor and Fragrance Molecules on Various Insect Species”, B. D. Mookherjee et al., published in Bioactive Volatile Compounds from Plants, ACS Symposium Series 525, R. Teranishi, R. G. Buttery, and H. Sugisawa, 1993, pp. 35-48, all of said patents and publications being incorporated herein by reference.

What is claimed is:

1. A method for cleaning fabric articles in need of cleaning comprising contacting said fabric articles in need of cleaning with a cleaning composition comprising a lipophilic fluid and water; wherein the amount of water in the cleaning composition is selected based upon the type of fabric articles being cleaned.

2. The method according to claim 1 wherein the fabric articles are contacted by the cleaning composition in a fabric article cleaning chamber of an automatic laundry machine capable of varying the amount of water present in the fabric article cleaning chamber.

3. The method according to claim 2 wherein the automatic laundry machine is preprogrammed to use a selected amount of water, based upon the type of fabric articles being cleaned, in the cleaning composition to contact the fabric articles during operation of the cleaning method.

4. The method according to claim 3 wherein the automatic laundry machine automatically selects the amount of water to be used.

5. The method according to claim 4 wherein the selection of the amount of water by the automatic laundry machine is in response to a sensor in the automatic laundry machine which detects the types of fabric articles within its fabric article cleaning chamber.

6. The method according to claim 5 wherein the sensor reads a label attached to the fabric articles and selects an amount of water safe for all the fabric articles being cleaned.

7. The method according to claim 4 wherein the automatic selection of the amount of water is in response to information about the fabric articles to be cleaned provided to the automatic laundry machine by an operator.

8. The method according to claim 3 wherein the operator selects the amount of water to be used from a preprogrammed option within the automatic laundry machine.

9. The method according to claim 1 wherein the fabric articles to be cleaned include a fabric article selected from the group consisting of silks, wools, rayon and mixtures thereof, and these fabric articles are cleaned in the automatic laundry machine with a cleaning composition comprising less than about 1% water by weight of the cleaning composition.

10. The method according to claim 1 wherein the fabric articles to be cleaned include fabric articles selected from the group consisting of cotton, polyester, nylon, and polycottons and mixtures thereof, and these fabric articles are cleaned in the automatic laundry machine with a cleaning composition comprising less than about 50% water by weight of the cleaning composition.

11. An automatic laundry machine for cleaning fabric articles, said machine being designed to clean fabric articles by allowing a cleaning composition comprising a lipophilic fluid and water to contact the fabric articles present within the machine, wherein said automatic laundry machine is capable of carrying out the cleaning process by using different amounts of water in the cleaning composition based on the types of fabric articles to be cleaned.

12. The automatic laundry machine according to claim 11 wherein the automatic laundry machine comprises a fabric article cleaning chamber within which the fabric articles are contacted by the cleaning composition.

13. The automatic laundry machine according to claim 11 wherein the automatic laundry machine is preprogrammed to use for the cleaning process a select level of water in combination with a lipophilic fluid based on the type of fabric articles to be cleaned.

14. The automatic laundry machine according to claim 10 wherein the machine is equipped with a sensor which detects the types of fabric article being cleaned.

15. The automatic laundry machine according to claim 10 wherein the machine is preprogrammed with options for the machine operator to select the level of water to be used.

16. The automatic laundry machine according to claim 10 wherein the machine has a connection for attachment to a source of water.

17. The automatic laundry machine according to claim 10 wherein the machine is equipped with a water sensor which detects the level of water in the cleaning composition in contact with the fabric articles being cleaned.

18. A method for cleaning fabric articles in need of cleaning, said method comprising contacting said fabric articles in need of cleaning with a cleaning composition comprising a lipophilic fluid and water; wherein the amount of water in the cleaning composition is selected based upon the amount of soil on said fabric articles being cleaned.

19. The method according to claim 18 wherein the fabric articles are contacted by the cleaning composition in a fabric article cleaning chamber of an automatic laundry machine capable of varying the amount of water present in the fabric article cleaning chamber.

20. The method according to claim 19 wherein the automatic laundry machine is preprogrammed to use a selected amount of water, based upon the amount of soil on said fabric articles being cleaned and optionally, based upon the type of fabric articles being cleaned, in the cleaning composition to contact the fabric articles during operation of the cleaning method.

21. The method according to claim 20 wherein the automatic laundry machine automatically selects the amount of water to be used.

22. The method according to claim 21 wherein the selection of the amount of water by the automatic laundry machine is in response to a sensor in the automatic laundry machine which detects the amount of soil on the fabric articles to be cleaned and/or the types of fabric articles present within its fabric article cleaning chamber.

23. The method according to claim 22 wherein the sensor reads a label attached to the fabric articles and selects an amount of water safe for all the fabric articles being cleaned.

24. The method according to claim 21 wherein the automatic selection of the amount of water is in response to information about the fabric articles to be cleaned provided to the automatic laundry machine by an operator.

25. The method according to claim 20 wherein the operator selects the amount of water to be used from a preprogrammed option within the automatic laundry machine.

26. The method according to claim 18 wherein the fabric articles to be cleaned include a fabric article selected from the group consisting of silks, wools, rayon and mixtures thereof, and these fabric articles are cleaned in the automatic laundry machine with a cleaning composition comprising less than about 1% water by weight of the cleaning composition.

27. The method according to claim 18 wherein the fabric articles to be cleaned include fabric articles selected from the group consisting of cotton, polyester, nylon, and polycottons and mixtures thereof, and these fabric articles are cleaned in the automatic laundry machine with a cleaning composition comprising less than about 50% water by weight of the cleaning composition.

28. An automatic laundry machine for cleaning fabric articles, said automatic laundry machine being designed to clean fabric articles by allowing a cleaning composition comprising a lipophilic fluid and water to contact the fabric articles present within the machine, wherein said machine is capable of carrying out cleaning wash process by using different amounts of water in the cleaning composition based on the soil level on the fabric articles to be cleaned.

29. The automatic laundry machine according to claim 28 wherein the automatic laundry machine comprises a fabric article cleaning chamber within which the fabric articles are contacted by the cleaning composition.

30. The automatic laundry machine according to claim 28 wherein the automatic laundry machine is preprogrammed to use for the cleaning process a select level of water in combination with a lipophilic fluid based on the type of fabric articles to be cleaned.

31. The automatic laundry machine according to claim 28 wherein the automatic laundry machine is equipped with a sensor which detects the types of fabric articles being cleaned.

32. The automatic laundry machine according to claim 28 wherein the automatic laundry machine is preprogrammed with options for the machine operator to select the level of water to be used.

33. The automatic laundry machine according to claim 28 wherein the automatic laundry machine has a connection for attachment to a source of water.

34. The automatic laundry machine according to claim 28 wherein the automatic laundry machine is equipped with a water sensor which detects the level of water in the cleaning composition in contact with the fabric articles being cleaned.

35. A method for cleaning fabric articles in need of cleaning, said method comprising contacting said fabric articles in need of cleaning with a cleaning composition comprising a lipophilic fluid, wherein said lipophilic fluid comprises less than about 1% water by weight of the lipophilic fluid, and water; wherein the fabric articles are subsequently contacted by said non-lipophilic fluid water.

36. A method for cleaning fabric articles according to claim 35 wherein the total water level present in the cleaning composition is less than about 50% by weight of the cleaning composition.

37. A method for cleaning fabric articles according to claim 35 where cleaning additives are added to the lipophilic fluid.

38. A method for cleaning fabric articles according to claim 35 where cleaning additives are added to the non-lipophilic fluid water.

39. A method for cleaning fabric articles in need of cleaning, said method comprising contacting said fabric articles in need of cleaning with a cleaning composition comprising a lipophilic fluid and water, wherein the fabric articles are contacted by the water subsequent to being contacted by the lipophilic fluid.

40. A method for cleaning fabric articles according to claim 39 wherein the total water level present in the cleaning composition is less than about 50% by weight of the cleaning composition.

41. A method for cleaning fabric articles according to claim 39 wherein the total water level present in the cleaning composition is less than about 50% by weight of the cleaning composition.

42. A method for cleaning fabric articles according to claim 39 wherein cleaning additives are added to the lipophilic fluid.

43. A method for cleaning fabric articles according to claim 39 wherein cleaning additives are added to the non-lipophilic fluid water.

44. A method for cleaning fabric articles in need of cleaning comprising contacting the fabric articles in need of cleaning with a cleaning composition comprising a lipophilic fluid and a lipophilic cosolvent, wherein the lipophilic cosolvent is present in the cleaning composition at a level of from about 0.1% to about 35% by weight of the cleaning composition; wherein the lipophilic cosolvent forms an azeotrope with water such that water can be incorporated as a third solvent in the cleaning composition; and wherein the water is present in the cleaning composition at a level of from about 0.5% to about 25% by weight of the cleaning composition.

45. The method for cleaning fabric articles according to claim 44 where the cosolvent is selected from glycol ethers.

46. A method for cleaning fabric articles according to claim 44 where detergent additives are added to the lipophilic fluid.
